(19) United States
(12) Patent Application Publication
(10) Pub. No.: US 2025/0053887 A1
(43) Pub. Date: Feb. 13, 2025

(54) SYSTEM FOR BOOKING OF LAB MEASUREMENT DEVICES

(71) Applicant: Rohde & Schwarz GmbH & Co. KG, Munich (DE)

(72) Inventor: Matt CORNISH, Hampshire (GB)

(73) Assignee: Rohde & Schwarz GmbH & Co. KG, Munich (DE)

(21) Appl. No.: 18/448,647

(22) Filed: Aug. 11, 2023

(51) Int. Cl. G06Q 10/02

(52) U.S. Cl. CPC G06Q 10/02

(57) ABSTRACT

A system for booking of lab measurement devices is provided. The system comprises a user workstation and one or more lab networks being connected to the user workstation, the respective lab network of the one or more lab networks comprising a lab workstation and one or more measurement devices. The lab workstation or any one of the one or more measurement devices comprises a booking service for the one or more measurement devices of the respective lab network. The booking service comprises a discovery service for the booking service, a web interface for making bookings and a REST interface for an automated retrieval of bookings. The user workstation is configured to remotely access the booking service of the respective lab network in accordance with existing IT access rights of a user of the user workstation. This minimizes administrative burden in multi-site/lab environments.

### TECHNICAL FIELD

The present disclosure relates generally to management of lab measurement devices, and particularly to a system for booking of lab measurement devices.

### BACKGROUND ART

Test & Measurement companies typically have multiple sites/labs. Each site may have a number of networked instruments, and user access may be granted between sites by the company's IT system.

Where instruments are shared, it is often required to book/reserve their use. Existing instrument access solutions therefore rely on integrated instrument booking systems to manage instrument availability and protect active users from interruptions.

An instrument booking system typically includes a single database and application, remotely accessed from around a network. This has a number of limitations for companies with multiple sites/labs:
The booking system must be accessible throughout the network, and in a known location.
Instruments must be manually added to the system, especially identifying their site.
Users must be configured in the system, according to which sites they may access.
No one authority necessarily has administrative rights to implement a booking system across all sites.

The above points make it difficult to coordinate the booking system with an instrument access system or directory.

### SUMMARY

It is an object to overcome the above-mentioned and other drawbacks.

The foregoing and other objects are achieved by the features of the independent claims. Further implementation forms are apparent from the dependent claims, the description and the figures.

A system for booking of lab measurement devices is provided. The system comprises a user workstation and one or more lab networks being connected to the user workstation, the respective lab network of the one or more lab networks comprising a lab workstation and one or more measurement devices. The lab workstation or any one of the one or more measurement devices comprises a booking service for the one or more measurement devices of the respective lab network. The booking service comprises a discovery service for the booking service, a web interface for making bookings and a REST interface for an automated retrieval of bookings. The user workstation is configured to remotely access the booking service of the respective lab network in accordance with existing IT access rights of a user of the user workstation.

A “system” as used herein may refer to an arrangement of networked sites, devices and/or services.

A “site” as used herein may refer to a geographic and/or administrative domain of a corporate network.

A “service” as used herein may refer to a server or server application serving a party requesting said service, such as a remote access service (i.e., acting as a relay/proxy) or a booking service.

“Booking” as used herein may refer to an act of reserving.

A “lab measurement device” as used herein may refer to Test & Measurement equipment such as a signal generator, a vector signal analyzer, and the like.

The booking service of the respective lab network may comprise one or more booking entries for the one or more measurement devices of the corresponding lab network.

The booking service of the respective lab network may be configured to allow the user of the user workstation to query, edit and/or create the booking entries.

The booking entries may respectively comprise one or more of: a hostname of the corresponding measurement device, a medium access control, MAC, address of the corresponding measurement device, and a reservation time period.

A “hostname” as used herein may refer to a label being assigned to a device connected to a computer network and that is used to identify said device.

A “MAC” address as used herein may refer to a unique network address within a site on layer two of the ISO/OSI reference architecture.

The booking entries may respectively exist until the expiry of the respective reservation time period.

The user workstation may further be configured to remotely access the one or more measurement devices of the respective lab network in accordance with existing IT access rights of a user of the user workstation and the booking service of the respective lab network.

### Advantageous Effects

The provided distributed instrument booking system is based on local, discoverable booking service instances which may be installed on any one machine (including instruments) at the respective site.

The local booking service is automatically discovered at the same time as the instruments it holds bookings for. A cross-site instrument access system can thus automatically discover, present and manage instrument availability for each instrument that it discovers at a given site.

The disclosed booking service simply follows existing IT rules for each site. Therefore, the booking system does not need to be configured with users' access rights because the IT system already limits access to the parts of the system where the user has access to instruments. Users with IT access to a site can automatically see the instruments and their bookings, but not those at other sites.

The disclosed booking service makes is easy to manage sites as needed, while leaving others unmanaged. That is to say, not all available instruments or sites need be part of the booking service, and the booking service need not be accessible across all sites and needs no specific central server.

The disclosed booking service negates the need for configuration of instruments, users and sites.

The instruments and bookings are all associated together with the site by using a combination of instrument MAC address and strong hostname. Instruments' sites and subnets are automatically identified.

In summary, the provided distributed instrument booking system minimizes administrative burden in multi-site/lab environments.

### BRIEF DESCRIPTION OF DRAWINGS

The above-described aspects and implementations will now be explained with reference to the accompanying drawings, in which the same or similar reference numerals designate the same or similar elements.

The features of these aspects and implementations may be combined with each other unless specifically stated otherwise.

The drawings are to be regarded as being schematic representations, and elements illustrated in the drawings are not necessarily shown to scale. Rather, the various elements are represented such that their function and general purpose become apparent to those skilled in the art.

FIG. 1 illustrates a system for booking of lab measurement devices in accordance with the present disclosure;

FIG. 2 illustrates details of the respective lab network of the system of FIG. 1; and

FIG. 3 illustrates details of the booking service of the lab network of FIG. 2.

### DETAILED DESCRIPTIONS OF DRAWINGS

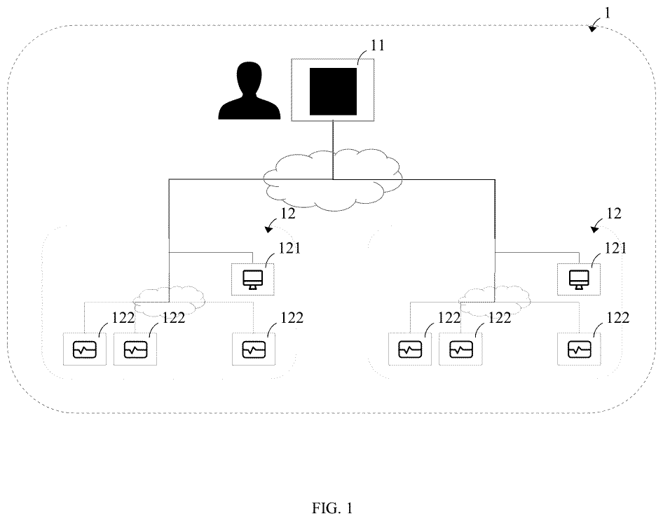

FIG. 1 illustrates a system 1 for booking of lab measurement devices 122 in accordance with the present disclosure.

In accordance with FIG. 1, the system 1 comprises a user workstation 11 and one or more lab networks 12. Notwithstanding the illustration, more than two lab networks 12 may be present.

The respective lab network 12 comprises a lab workstation 121 and one or more measurement devices 122, being connected to the user workstation 11.

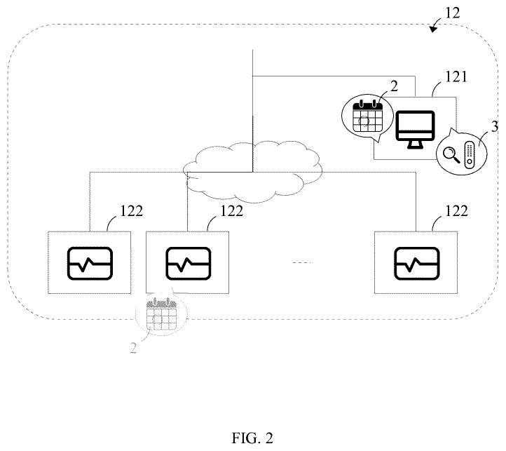

FIG. 2 illustrates details of the respective lab network 12 of the system 1 of FIG. 1.

In accordance with FIG. 2, the lab workstation 121 or any one of the measurement devices 122 may comprise a booking service 2 for the one or more measurement devices 122 of the respective lab network 12.

For example, the second measurement device 122 from the left of FIG. 2 may comprise the booking service 2 for the measurement device 122 itself and any other measurement device 122 within the same lab network 12. Alternatively, the lab workstation 121 may comprise the booking service 2 for the one or more measurement devices 122 of the lab network 12.

The booking service 2 further comprises a discovery service 3 for the booking service 2.

The user workstation 11 is configured to remotely access the booking service 2 of the respective lab network 12 in accordance with existing IT access rights of a user of the user workstation 11. For example, said remote access may display a dashboard where further actions can be carried out and, in particular, remote access to the instruments 122 of the respective lab workstation 121.

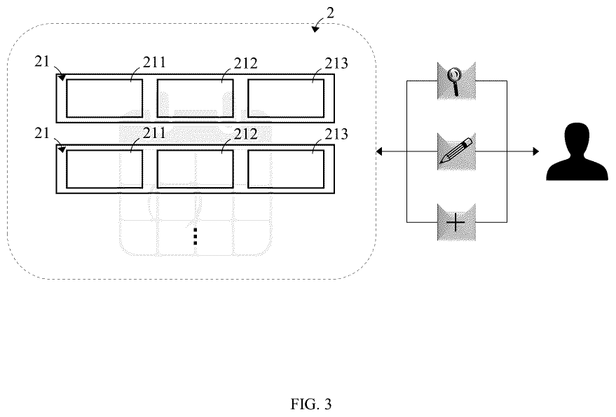

FIG. 3 illustrates details of the booking service 2 of the lab network 12 of FIG. 2.

In accordance with a left side of FIG. 3, the booking service 2 of the respective lab network 12 may comprise one or more booking entries 21 for the one or more measurement devices 122 of the corresponding lab network 12.

The booking entries 21 may respectively comprise one or more of: a hostname 211 of the corresponding measurement device 122, a medium access control (MAC) address 212 of the corresponding measurement device 122, and a reservation time period 213.

In accordance with a right side of FIG. 3, the booking service 2 of the respective lab network 12 may be configured to allow the user of the user workstation 11 to query, edit and/or create the booking entries 21, as indicated by magnifying glass, pencil and plus symbols.

The booking entries 21 may respectively exist until the expiry of the respective reservation time period 213. In other words, the booking service 2 implies a bare minimum of data management relating to the booking of lab measurement devices 122.

The user workstation 11 may further be configured to remotely access the one or more measurement devices 122 of the respective lab network 12 in accordance with existing IT access rights of a user of the user workstation 11 and the booking service 2 of the respective lab network 12.

1. A system for reserving of lab measurement devices, comprising:
a user workstation; and
one or more lab networks being connected to the user workstation,
the respective lab network of the one or more lab networks comprising:
a lab workstation; and
one or more measurement devices;
the lab workstation or any one of the one or more measurement devices comprising:
a reserving server for the one or more measurement devices of the respective lab network;
the reserving server comprising:
a discovery server application for the reserving server;
a web interface for making reserving; and
a Representational State Transfer (REST) interface for an automated retrieval of reserving;
the user workstation being configured to remotely access the reserving server of the respective lab network in accordance with existing Information Technology (IT) access rights of a user of the user workstation,
wherein the reserving server of the respective lab network comprises a database of reserving entries for the one or more measurement devices of the corresponding lab network, and
wherein the reserving server of the respective lab network is configured to allow the user of the user workstation to edit the reserving entries, the reserving entries respectively comprising a Medium Access Control, MAC, address of the corresponding measurement device.

2. (canceled)

3. (canceled)

4. The system of claim 1,
the reserving entries respectively comprising one or more of:
a hostname of the corresponding measurement device,
and
a time period of the reserving.

5. The system of claim 4,
the reserving entries respectively existing until the expiry of the respective time period.

6. The system of claim 1,
the user workstation further being configured to remotely access the one or more measurement devices of the respective lab network in accordance with existing Information Technology (IT) access rights of a user of the user workstation.

7. A measurement device, comprising:
a reserving server for the measurement device and any other measurement device within a same lab network,
wherein the reserving server comprises a database of reserving entries for the one or more measurement devices of the corresponding lab network, and
wherein the reserving server is configured to allow a user of a user workstation to edit the reserving entries, the reserving entries respectively comprising a Medium Access Control,
MAC, address of the corresponding measurement device.
